(19) United States
(12) Patent Application Publication
(10) Pub. No.: US 2023/0263688 A1
(43) Pub. Date: Aug. 24, 2023

(54) EXOSKELETON SYSTEMS AND METHODS OF USE

(71) Applicant: Georgia Tech Research Corporation, Atlanta, GA (US)

(72) Inventors: Aaron Young, Atlanta, GA (US); Inseung Kang, Atlanta, GA (US); Dawit Lee, Atlanta, GA (US)

(21) Appl. No.: 18/003,927

(22) PCT Filed: Jul. 1, 2021
(86) PCT No.: PCT/US2021/040068

§ 371 Date: Dec. 30, 2022

Related U.S. Application Data
(60) Provisional application No. 63/046,956, filed on Jul. 1, 2020.

(51) Int. Cl. A61H 3/00

(52) U.S. Cl. CPC A61H 3/00; A61H 2003/007; A61H 2201/164; A61H 2201/1628; A61H 2201/165; A61H 2230/655; A61H 2230/625

(57) ABSTRACT

An exemplary embodiment of the present disclosure provides a knee exoskeleton comprising a first interface, a second interface, an actuator, and a controller. The first interface can be configured to interface with a portion of a leg of a user above a knee joint of the user. The second interface can be configured to interface with a portion of the leg of the user below the knee joint of the user. The actuator can be configured to generate a torque to cause a movement of at least one of the first and second interfaces. The controller can be configured to control the actuator to vary the magnitude of torque generated by the actuator.

### CROSS-REFERENCE TO RELATED APPLICATIONS

This application claims the benefit of U.S. Provisional Application Ser. No. 63/046,956, filed on 1 Jul. 2020, which is incorporated herein by reference in its entirety as if fully set forth below.

### GOVERNMENT LICENSE RIGHTS

This invention was made with government support under Agreement No. FD004193, awarded by Food and Drug Administration, and Agreement No. 1830215, awarded by National Science Foundation. The government has certain rights in the invention.

### FIELD OF THE DISCLOSURE

The various embodiments of the present disclosure relate generally to exoskeletons, and more particularly to joint exoskeletons.

### BACKGROUND

The field of powered exoskeleton technology has been actively developed over the past years. Exoskeleton technology holds a large potential to help improve human mobility and physical capability. Therefore, the effectiveness of using exoskeletons has been widely investigated in various applications including augmenting human performance, assisting impaired population, and therapeutic purposes. The current gold standard measurement for human performance augmentation in the field is metabolic cost. This is achieved by replacing the user's biological joint effort required by muscles to perform a certain locomotor task. For walking, many exoskeletons target the hip and/or ankle joints because these joints contribute to the majority of the total positive mechanical work during level-ground walking. Despite there being fewer studies that have targeted the knee joint to date for human performance augmentation, previous studies have investigated the efficacy of utilizing knee exoskeletons in assisting the user with different locomotor tasks. The majority of these studies have focused on one of the following tasks: developing high torque, light weight, and low-profile devices, control strategies for level-ground tasks, or investigating the effect of the exoskeleton system on the user during level ground walking. During level ground walking, the knee joint produces a very small amount of positive mechanical work compared to the other lower-limb joints; however, the contribution of the knee joint becomes greater during inclined walking, up to approximately 25% of the total positive power. The positive power generation of the knee joint during incline walking is primarily present during the early stance phase through an extension moment. Thus, one potentially promising strategy that knee exoskeletons have exploited is to provide early stance phase knee extension support. For instance, the inventors previous work examined providing early stance assistance with a biological torque controller using a unilateral knee exoskeleton during incline walking. The results of that work indicated that only half of the individuals achieved metabolic reduction with the assistance while the other half did not. The primary biomechanical difference between individuals with (responders) and without (nonresponders) metabolic reduction was that nonresponders exhibited increased muscle activation of the knee extensor group on the unassisted leg when assistance was provided whereas the responders did not. This suggests that assisting the user's knee joints bilaterally could potentially eliminate the role of the unassisted leg that led to increased metabolic cost for nonresponders.

Further, many conventional exoskeletons suffer from disadvantages with the way the exoskeleton interfaces with the user's body. For example, when a user wears an exoskeleton, the weight of the exoskeleton must be supported. Without some form of mechanical support, the exoskeleton will slide down the user's legs over time due to the cyclical stresses induced during walking. In some instances, a shank and thigh orthotic alone are insufficient to support the exoskeleton's weight. Motion of the exoskeleton relative to the user's legs can result in misalignment of the biological and mechanical joints, which can have a negative impact on the exoskeleton's ability to assist users. Several conventional exoskeletons have relied on an insert in the user's shoe along with a rigid bar connecting the insert to the distal end of the device to support the exoskeleton's weight. While effective, this design adds a large amount of time and effort to don and doff the device and can also cause discomfort in the user due to chafing of the foot and ankle.

It is also desirable for knee exoskeletons to be capable of adapting to the ground slope over which the user walks. Since the mechanical work done by the knee joint increases when the user walks up inclined terrain, scaling the magnitude of exoskeleton assistance with ground slope can improve the device's efficacy in reducing the metabolic cost of walking. conventional ground-slope estimation methods commonly compute slope from sensor data algorithmically. One existing approach is to integrate acceleration data from an inertial measurement unit (IMU) on the shank or foot. However, these methods are susceptible to sensor drift and additionally rely on the cyclical nature of walking to operate. However, in a real-world walking scenario where slope can dynamically vary, the assumption of cyclical walking may be violated, rendering these methods unsuitable. Other methods measure joint angles and segment orientation with mechanical sensors. Using these angles, the ground slope is calculated with geometric relations. Notably, all existing slope estimation methods are restricted to updating the estimate after heel-contact. For a knee exoskeleton, where large assistance torque is applied immediately following heel contact, this delays the update to assistance magnitude.

Accordingly, there is a need for improved exoskeletons, and in particular knee exoskeletons, that can assist users with walking on both level and sloped surfaces while providing support on an as-needed basis.

### BRIEF SUMMARY

The present disclosure relates to exoskeletons for providing joint movement assistance to a user. An exemplary embodiment of the present disclosure provides a knee exoskeleton comprising a first interface, a second interface, an actuator, and a controller. The first interface can be configured to interface with a portion of a leg of a user above a knee joint of the user. The second interface can be configured to interface with a portion of the leg of the user below the knee joint of the user. The actuator can be configured to generate a torque to cause a movement of at least one of the first and second interfaces. The controller can be configured to control the actuator to vary the magnitude of torque generated by the actuator.

In any of the embodiments disclosed herein, the first interface can comprise a hip interface, a thigh interface, and an interface joint. The hip interface can be configured to interface with a hip of the user. The thigh interface can be configured to interface with a thigh of the user. The interface joint can mechanically connect the hip interface and the thigh interface and allow the thigh interface to move relative to the hip interface.

In any of the embodiments disclosed herein, the first interface can further comprise a first rigid bar connecting the hip interface to the interface joint.

In any of the embodiments disclosed herein, the first interface can further comprise a second rigid bar connecting the thigh interface to the interface joint.

In any of the embodiments disclosed herein, the interface joint can be configured to allow the thigh interface to move relative to the hip interface with two degrees of freedom.

In any of the embodiments disclosed herein, the interface joint can comprise a two degrees of freedom free joint and a one degree of freedom locking joint.

In any of the embodiments disclosed herein, the interface joint can be configured to allow the thigh interface to move relative to the hip interface in extension/flexion and abduction/adduction directions.

In any of the embodiments disclosed herein, the interface joint can be configured to allow the thigh interface to rotate relative to the hip interface in a medial/lateral direction.

In any of the embodiments disclosed herein, the actuator can comprise a planetary gear system.

In any of the embodiments disclosed herein, the planetary gear can have a gear ratio of about 9:1.

In any of the embodiments disclosed herein, the controller can be configured as an impedance controller to vary the magnitude of the torque based on one or more kinematic measurements of the user's movement.

In any of the embodiments disclosed herein, the controller can be configured to operate as a finite state machine having a plurality of states. Each of the plurality of states can correspond to a distinct portion of a gait cycle.

In any of the embodiments disclosed herein, the plurality of states can comprises: a first state corresponding to an early stance of the gait cycle; a second state corresponding to a late stance of the gait cycle; a third state corresponding to a swing flexion of the gait cycle; and a fourth state correspond to a swing extension of the gait cycle.

In any of the embodiments disclosed herein, the controller can be configured to transition from the first state to the second state when the controller receives data indicative that the user has completed a predetermined percentage of the of stance phase.

In any of the embodiments disclosed herein, the controller can be configured to transition from the second state to the third state when the controller receives data indicative of the user's toes on a leg corresponding to the knee exoskeleton has been lifted from the ground.

In any of the embodiments disclosed herein, the controller can be configured to transition from the third state to the fourth state when the controller receives data indicative of the user's knee velocity on a leg corresponding to the knee exoskeleton falls below a predetermined threshold.

In any of the embodiments disclosed herein, the controller can be configured to transition from the fourth state to the first state when the controller receives data indicative of the user's heel contacting a ground.

In any of the embodiments disclosed herein, the controller can be configured to vary the magnitude of torque generated by the actuator based, at least in part, on a current state of the finite state machine.

In any of the embodiments disclosed herein, the controller can be configured to vary the magnitude of the torque generated by the actuator based, at least in part, on the equation:

τᵢ=k(θᵢ− [symbol] _{equilibrium})+b\dot{θ}ᵢ

wherein θᵢ refers to knee joint angle, \dot{θ}ᵢ refers to knee joint velocity, k refers a stiffness constant, b refers to a damping coefficient, and θ_{equilibrium} is an equilibrium angle which is a target knee joint angle.

In any of the embodiments disclosed herein, the controller can be further configured to determine a current ground slope on which the user is currently walking.

In any of the embodiments disclosed herein, the controller can be further configured to determine a current ground slope on which the user is currently walking by using a user-independent real-time machine learning model which implements a convolutional neural network.

In any of the embodiments disclosed herein, the knee exoskeleton can further comprise a plurality of sensors, wherein the real-time machine learning model receives input from the plurality of sensors.

In any of the embodiments disclosed herein, the plurality of sensors comprises one or more of: an encoder positioned proximate the knee joint of the user; a first inertial measurement unit positioned proximate the first interface; a second inertial measurement unit positioned proximate the second interface; and a force-sensitive resistor proximate a heel of the user.

In any of the embodiments disclosed herein, the real-time machine learning model can receive input from the plurality of sensors each time the user's heel strikes the ground.

In any of the embodiments disclosed herein, the controller can be configured to vary the magnitude of the torque generated by the actuator based, at least in part, on the determined current ground slope.

Another embodiment of the present disclosure provides an exoskeleton for assisting movement of a joint of a user. The exoskeleton can comprise an interface, an actuator, and a controller. The interface can be configured to attach to a portion of a body of the user proximate a side of the user's joint. The actuator can be configured to generate a torque to cause a movement of the interface to assist the user with movement of the joint. The controller can be configured to control the actuator to vary the magnitude of the torque generated by the actuator.

In any of the embodiments disclosed herein, the controller can be configured to operate as a finite state machine having a plurality of states, each of the plurality of states corresponding to a distinct portion of a cycle of the user's movement of the joint.

In any of the embodiments disclosed herein, the controller can be configured to vary the magnitude of the torque generated by the actuator based, at least in part, on the equation:

τᵢ=k(θᵢ− [symbol] _{equilibrium})+b\dot{θ}ᵢ

wherein θᵢ refers to joint angle, \dot{θ}ᵢ refers to joint velocity, k refers a stiffness constant, b refers to a damping coefficient, and θ_{equilibrium} is an equilibrium angle which is a target joint angle.

In any of the embodiments disclosed herein, the joint can be a knee joint.

These and other aspects of the present disclosure are described in the Detailed Description below and the accompanying drawings. Other aspects and features of embodiments will become apparent to those of ordinary skill in the art upon reviewing the following description of specific, exemplary embodiments in concert with the drawings. While features of the present disclosure may be discussed relative to certain embodiments and figures, all embodiments of the present disclosure can include one or more of the features discussed herein. Further, while one or more embodiments may be discussed as having certain advantageous features, one or more of such features may also be used with the various embodiments discussed herein. In similar fashion, while exemplary embodiments may be discussed below as device, system, or method embodiments, it is to be understood that such exemplary embodiments can be implemented in various devices, systems, and methods of the present disclosure.

### BRIEF DESCRIPTION OF THE DRAWINGS

The following detailed description of specific embodiments of the disclosure will be better understood when read in conjunction with the appended drawings. For the purpose of illustrating the disclosure, specific embodiments are shown in the drawings. It should be understood, however, that the disclosure is not limited to the precise arrangements and instrumentalities of the embodiments shown in the drawings.

FIG. 1 provides a knee exoskeleton, in accordance with an exemplary embodiment of the present disclosure.

FIG. 2 provides an interface of a knee exoskeleton, in accordance with an exemplary embodiment of the present disclosure.

FIG. 3 illustrate a perspective view of an actuator for use in an exoskeleton, in accordance with an exemplary embodiment of the present disclosure.

FIG. 4 provides a flow chart of a finite state machine implemented by a controller of an exoskeleton, in accordance with an exemplary embodiment of the present disclosure.

### DETAILED DESCRIPTION

To facilitate an understanding of the principles and features of the present disclosure, various illustrative embodiments are explained below. The components, steps, and materials described hereinafter as making up various elements of the embodiments disclosed herein are intended to be illustrative and not restrictive. Many suitable components, steps, and materials that would perform the same or similar functions as the components, steps, and materials described herein are intended to be embraced within the scope of the disclosure. Such other components, steps, and materials not described herein can include, but are not limited to, similar components or steps that are developed after development of the embodiments disclosed herein.

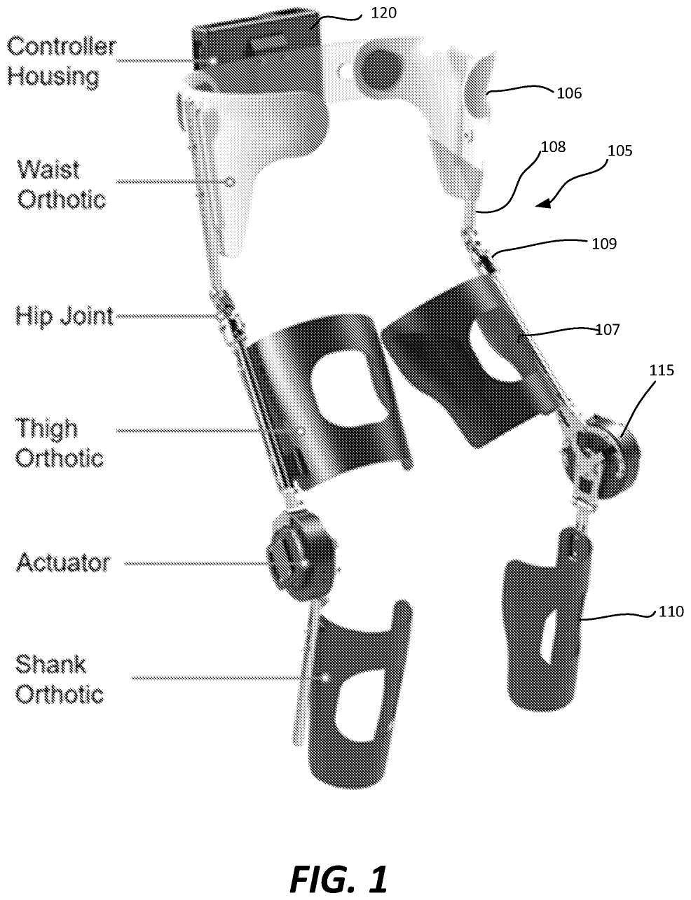

As shown in FIG. 1, an exemplary embodiment of the present disclosure provides a knee exoskeleton comprising a first interface 105, a second interface 110, an actuator 115, and a controller 120. The first and second interfaces 105 110 can be any type of interfaces known in the art. In some embodiments, the first and second interfaces 105 110 can be orthotics designed to interface with particular portions of the user's body. For example, as shown in FIG. 1, the first interface 105 comprises an orthotic configured to interface with the thigh of the user, and the second interface 110 comprises an orthotic configured to interface with the lower shank of the user. The interfaces 105 110 can be made of many different materials, including, but not limited to, metals, plastics, fiber glass, carbon fiber, and the like. In some embodiments, each of the first and second interfaces 105 110 can comprise a rigid bar or other means for connecting the interfaces to the actuator. The interfaces 105 110 can be configured to interface with the portions of the user many different ways, such as with the use of straps, by surrounding at least a portion of the user (e.g., encircling a section of the leg), among others.

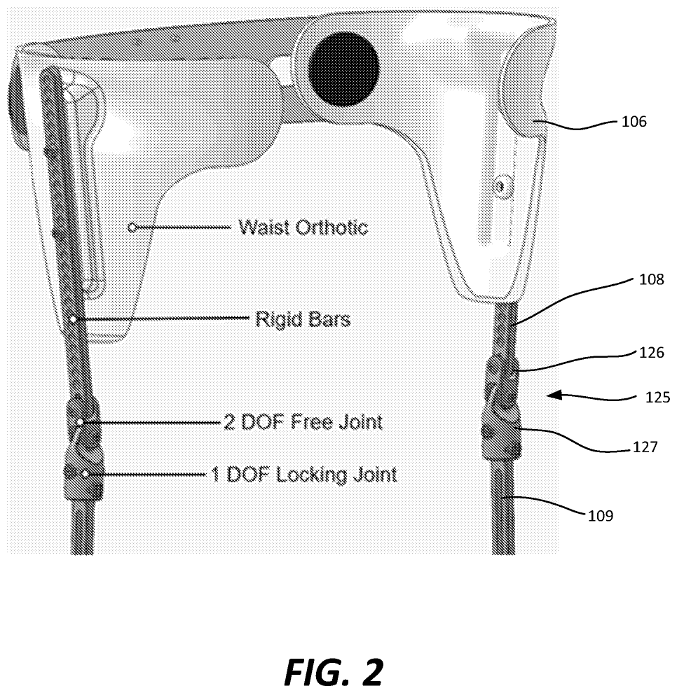

In some embodiments, the first interface 105 can comprise a hip interface 106, a thigh interface 107, and an interface joint 125, as shown in FIGS. 1-2. The hip interface 106 can be configured to interface with a hip of the user, for example, by attaching to the waist of the user. The thigh interface 107 can be configured to interface with a thigh of the user. The interface joint 125 can mechanically connect the hip interface 106 and the thigh interface 107 and allow the thigh interface 107 to move relative to the hip interface 106.

In some embodiments, the first interface 105 can further comprise one or more structural members for connecting the hip interface 106 to the thigh interface 107. In some embodiments, the structural member can comprise a strap. The use of a strap, however, can leave the exoskeleton susceptible to misalignment and downwards sliding due to loss of tension in the strap as the user flexes their hip.

Accordingly, in some embodiments, structural members can comprise a first rigid bar 108 connecting the hip interface 106 to the interface joint 125 and/or a second rigid bar 109 connecting the thigh interface 107 to the interface joint 125. The use of rigid bars can ensure that the exoskeleton remains well-aligned and well-fitted throughout the duration of walking. Because the bars can span the user's hip joint, it is desirable for the bars to allow hip motion in the extension/flexion and abduction/adduction directions for a comfortable walking experience. In some embodiments, this desired movement can be achieved by a two degree-of-freedom (DOF) free-pivoting joint 126 which joins the first and second rigid bars 108 109. By aligning the two DOF joint 126 with the user's hip joint, rigid support of the exoskeleton can be achieved while still allowing the user free movement of the hip. Specifically, the user of the two DOF free-pivoting joint 126 can allow the thigh interface 107 to move relative to the hip interface 106 in extension/flexion and abduction/adduction directions. Additionally, to accommodate any misalignment of the exoskeleton and user's leg along the axis of the rigid bar 109, a one DOF locking joint 127 can be incorporated in series with the two DOF free-pivoting joint 126. This allows the relative angle of the exoskeleton and user's leg to be tuned prior to walking and locked in place during ambulation. In other words, the one DOF locking joint 127 can allow the thigh interface 107 to rotate relative to the hip interface 106 in a medial/lateral direction.

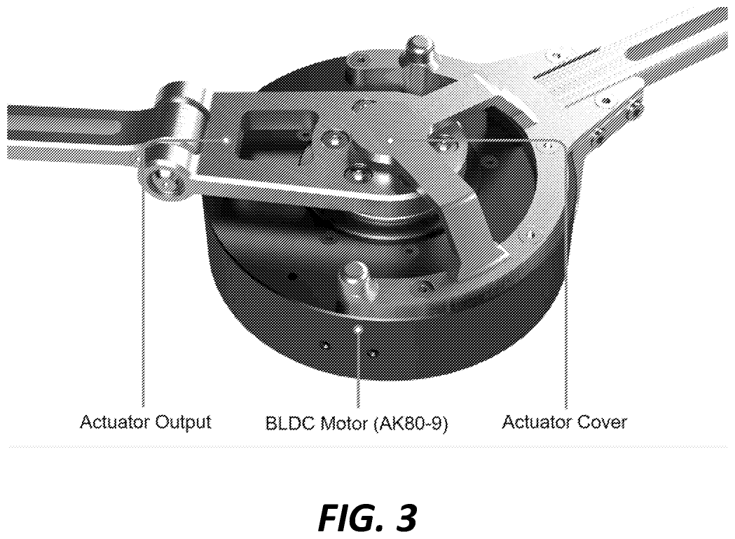

As discussed above, the exoskeleton can further comprise an actuator 115. The actuator 115 can be configured to generate a torque to cause a movement of at least one of the first and second interfaces 105 110. An exemplary embodiment of the actuator 115 is shown in FIG. 3. The actuator 115 can comprise an absolute rotary encoder, planet gears, a sun gear shaft, an actuator output, an actuator cover, and a brushless DC motor. The planetary gear system can be configured to have many different gear ratios in accordance with various embodiments, including, but not limited to, 1:1, 2:1, 3:1, 4:1, 5:1, 6:1, 7:1, 8:1, 9:1, 10:1, 11:1, 12:1, 13:1 14:1, 15:1, 16:1 17:1, 18:1, 19:1, 20:1, etc.

The actuator 115 can be provided to provide various ranges of motion for the flex of the joint in accordance embodiments. In some embodiments, the range of motion allows for 90° flexion and 20° extension.

The peak torque generated by the actuator 115 can also vary in accordance with various embodiments. In some embodiments, the peak torque can range from 1 Nm to 50 Nm, including any subrange therein. In some embodiments, the actuator 115 is configured to provide a peak torque of 18 Nm.

Similarly, the maximum continuous torque generated by the actuator 115 can also vary in accordance with various embodiments. In some embodiments, the maximum continuous torque can range from 1 Nm to 50 Nm, including any subrange therein. In some embodiments, the actuator 115 is configured to provide a maximum continuous torque of about 9 Nm.

The actuator 115 can also actuate at various maximum speeds in accordance with various embodiments. In some embodiments, the actuator 115 can actuate at a maximum speed ranging from 1-500 radians per second. In some embodiments, the actuator 115 can actuate at a maximum speed of about 33.3 radians per second.

As discussed above, the exoskeleton can further comprise a controller 120 configured to control the actuator 115 to vary the magnitude of torque generated by the actuator 115. The controller 120 can be many controllers known in the art. In some embodiments, the controller 120 comprises a processor and memory. The memory can comprise instructions that when executed by the processor can cause the processor to perform the various functions disclosed herein.

The controller 120 can be configured to implement many different control schemes. In some embodiments, the controller 120 can be implemented as a biological torque controller in which the assistance profile is based on human biomechanics data. With this scheme, the assistance profile can stay consistent during every gait cycle.

In some embodiments, the controller 120 can be implemented as a myoelectric controller. The myoelectric controller can utilize surface electromyography (EMG) signals from the user as an input. With the use of the biological muscle activation to control the assistance timing and magnitude, the user can adjust the assistance to their gait for step-to-step variability in real-time. The myoelectric controller can allow users to walk more naturally, which led to a larger reduction in muscle activation or metabolic cost compared to the biological torque controllers using hip and ankle exoskeletons. Allowing the user more control of the assistance may be more beneficial than allowing less because the powered assistance becomes more synchronized to the user's intention.

In some embodiments, the controller 120 can be implemented as an impedance controller. The impedance controller can model a joint as a spring-damper system. The impedance controller can regulate the torque output based on the input kinematics from the user, allowing the user to step up or down the torque by controlling their kinematics. This can allow the exoskeleton to smoothly provide assistance to the knee joint for individuals walking in excessively flexed knee, called crouch gait, or hyperextended knee, called genu recurvatum. In children walking with crouch gait, the knee joint mimics the mechanical behavior of a spring during the majority of the stance phase. This means that the biological knee joint moment can be predicted by monitoring the state of the knee angle, and the controller 120 can potentially respond to the user's need by adjusting the magnitude of assistance (i.e., torque provided by the actuator 115) in real-time.

The robotic knee exoskeleton can give a physical therapist (PT) more control over the rehabilitation process by specifying a patient's virtual ‘stiffness and damping’ at the knee during stance phase similar to an orthosis but without hard kinematic constraints that may prevent appropriate neuroplastic gait retraining. Additionally, children with abnormal walking patterns also exhibit a significantly limited range of motion during the swing phase. The robotic knee exoskeleton can provide active knee assistance during the swing phase of gait to help train the patient to use their full range of motion. This is typically done manually by the PT and is very difficult to do during walking. This assistance strategy can directly impact patients by giving physical therapists a new and powerful tool to help improve rehabilitation outcomes by providing new levels of control over the rehabilitation process that are not possible without robotic intervention.

In some embodiments, some of these benefits can be realized by configured the controller 120 to operate as a finite state machine, in which each state corresponds to a distinct portion of the gait cycle, which is a cycle repeated continuously of the person's walking pattern. The pattern of each leg can be divided into two parts: stance phase (a foot is in contact with the ground) and swing phase (a foot is off the ground). The stance phase can be further divided into an early stance phase and a late stance phase. The early stance phase is the first X % of the stance phase and the late stance phase is the rest of the stance phase after the early stance phase. The percentage of the stance phase that constitutes the early and late stance phases can be varied/tuned in accordance with different embodiments. The swing phase can also be further divided into a swing flexion phase (i.e., the portion of the swing phase when the user's knee flexes) and a swing extension phase (i.e., the portion of the swing phase when the user's knee extends).

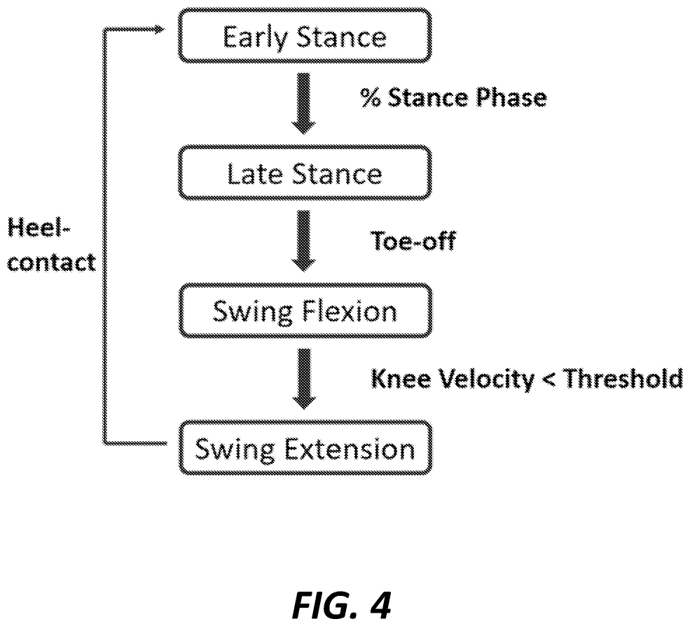

FIG. 4 illustrates the flow of an exemplary finite state machine. The exemplary finite state machine comprises four states. The first state corresponds to the early stance of the gait cycle. The second state corresponds to the late stance of the gait cycle. The third state corresponds to a swing flexion of the gait cycle. The fourth state corresponds to a swing extension of the gait cycle. As shown in FIG. 4, the controller transition from the first state to the second state when the controller 120 receives data indicative that the user has completed a predetermined percentage of the of stance phase. The controller 120 can transition from the second state to the third state when the controller 120 receives data indicative of the user's toes on the leg corresponding to the knee exoskeleton has been lifted from the ground. The controller 120 can transition from the third state to the fourth state when the controller 120 receives data indicative of the user's knee velocity on the leg corresponding to the knee exoskeleton falls below a predetermined threshold. Finally, the controller 120 can transition from the fourth state to the first state when the controller 120 receives data indicative of the user's heel on the leg corresponding to the knee exoskeleton contacting the ground.

The controller 120 can vary the magnitude of torque generated by the actuator 115 based, at least in part, on a current state of the finite state machine. For example, the controller 120 can be configured to vary the magnitude of the torque generated by the actuator 115 based, at least in part, on the following equation:

τᵢ=k(θᵢ− [symbol] _{equilibrium})+b\dot{θ}ᵢ

wherein θᵢ refers to knee joint angle, \dot{θ}ᵢ refers to knee joint velocity, k refers a stiffness constant, b refers to a damping coefficient, and θ_{equilibrium} is an equilibrium angle which is a target knee joint angle. During each state of gait cycle, the b, k, θ_{equilibrium} can be modulated to promote the user to achieve a specific kinematic goal for each state. The assistance can be turned on or off for each state. By varying the spring equilibrium angle of the controller 120 for each phase of gait cycle, the exoskeleton can help drive the kinematic trajectory of the knee joint close to that of normal walking. Thus, the controller 120 works as an assist-as-needed paradigm in that assistance can be proportional to how far the user's knee joint angle is from the clinically desired trajectory.

In some embodiments, the controller 120 can be further configured to determine a current ground slope on which the user is currently walking. The controller 120 can also vary the magnitude of the torque generated by the actuator 115 based, at least in part, on the determined current ground slope. In order to detect ground slope, in some embodiments, the exoskeleton can leverage an adaptable, real-time machine learning model which implements a convolutional neural network. The model can take input from mechanical sensors embedded on the device, such as an encoder at the knee joint and IMUs on the thigh and shank segments. Each time the user's heel strikes the ground—as detected by a force-sensitive resistor (FSR)—sensor data can be fed into the model which subsequently outputs the predicted ground slope. This predicted slope can be passed to the mid-level impedance controller to scale the assistance magnitude for the upcoming gait cycle. Notably, this model can be trained on a user-independent basis. In a real-world setting, this means that no user-specific adjustment or tuning is required for the estimator to function properly; rather, the device can be immediately deployed on any given user. In addition, this model predicts ground slope for the upcoming gait cycle, which means no delay is incurred in the update to assistance magnitude.

It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the United States Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way.

1. An exoskeleton comprising:
a first interface configured to interface with a portion of a body of a user proximate a joint of the user;
an actuator configured to generate a torque to cause a movement of the interface to assist the user with movement of the joint; and
a controller configured to control the actuator to vary the magnitude of torque generated by the actuator.

2. The exoskeleton of claim 1, further comprising a second interface:
wherein the first interface is configured to interface with a portion of a leg of the user above a knee joint of the user and comprises:
a hip interface configured to interface with a hip of the user;
a thigh interface configured to interface with a thigh of the user; and
an interface joint mechanically connecting the hip interface and the thigh interface and allowing the thigh interface to move relative to the hip interface;
wherein the second interface is configured to interface with a portion of the leg of the user below the knee joint of the user; and
wherein the actuator is configured to generate a torque to cause a movement of at least one of the first and second interfaces.

3. The exoskeleton of claim 2, wherein the first interface further comprises:
a first rigid bar connecting the hip interface to the interface joint; and
a second rigid bar connecting the thigh interface to the interface joint.

4. (canceled)

5. The exoskeleton of claim 2, wherein the interface joint is configured to allow the thigh interface to move relative to the hip interface:
with two degrees of freedom; and/or
in extension/flexion and abduction/adduction directions.

6. The exoskeleton of claim 2, wherein the interface joint comprises a two degrees of freedom free joint and a one degree of freedom locking joint.

7. (canceled)

8. The exoskeleton of claim 2, wherein the interface joint is configured to allow the thigh interface to rotate relative to the hip interface in a medial/lateral direction.

9. (canceled)

10. The exoskeleton of claim 2, wherein the actuator comprises a planetary gear system with a gear ratio of 9:1.

11. The exoskeleton of claim 2, wherein the controller is further configured as an impedance controller to vary the magnitude of the torque based on one or more kinematic measurements of the user's movement.

12. The exoskeleton of claim 2, wherein the controller is further configured to:
operate as a finite state machine having states, each of which correspond to a distinct portion of a gait cycle; and
vary the magnitude of torque generated by the actuator based, at least in part, on a current state of the finite state machine.

13. The exoskeleton of claim 12, wherein four of the states comprises:
a first state corresponding to an early stance of the gait cycle;
a second state corresponding to a late stance of the gait cycle;
a third state corresponding to a swing flexion of the gait cycle; and
a fourth state correspond to a swing extension of the gait cycle.

14. The exoskeleton of claim 2, wherein the controller is further configured to:
operate as a finite state machine having at least four states, each state corresponding to a distinct portion of a gait cycle selected from the group consisting of:
a first state corresponding to an early stance of the gait cycle;
a second state corresponding to a late stance of the gait cycle;
a third state corresponding to a swing flexion of the gait cycle; and
a fourth state correspond to a swing extension of the gait cycle; and
transition from at least one state to at least another state, the transition selected from the group consisting of:
a transition from the first state to the second state when the controller receives data indicative that the user has completed a predetermined percentage of the of stance phase;
a transition from the second state to the third state when the controller receives data indicative of the user's toes on a leg corresponding to the knee exoskeleton has been lifted from the ground;
a transition from the third state to the fourth state when the controller receives data indicative of the user's knee velocity on a leg corresponding to the knee exoskeleton falls below a predetermined threshold; and
a transition from the fourth state to the first state when the controller receives data indicative of the user's heel contacting a ground.

15.-18. (canceled)

19. The exoskeleton of claim 12, wherein the controller is further configured to vary the magnitude of the torque generated by the actuator based, at least in part, on the equation:
τᵢ=k(θᵢ−θ_{equilibrium})−b\dot{θ}ᵢ
wherein θᵢ refers to knee joint angle, \dot{θ}ᵢ refers to knee joint velocity, k refers a stiffness constant, b refers to a damping coefficient, and θ_{equilibrium} is an equilibrium angle which is a target knee joint angle.

20. (canceled)

21. The exoskeleton of claim 2, wherein the controller is further configured to determine a current ground slope on which the user is currently walking by using a user-independent real-time machine learning model which implements a convolutional neural network.

22. The exoskeleton of claim 21 further comprising sensors;
wherein the real-time machine learning model receives input from the sensors.

23. The exoskeleton of claim 22, wherein at least one sensor of the sensors is selected from the group consisting of:
an encoder positioned proximate the knee joint of the user;
a first inertial measurement unit positioned proximate the first interface;
a second inertial measurement unit positioned proximate the second interface; and
a force-sensitive resistor proximate a heel of the user.

24. The exoskeleton of claim 21, wherein the real-time machine learning model receives input each time the user's heel strikes the ground.

25. The exoskeleton of claim 21, wherein the controller is further configured to vary the magnitude of the torque generated by the actuator based, at least in part, on the determined current ground slope.

26. An exoskeleton for assisting movement of a joint of a user, the exoskeleton comprising:
an interface configured to attach to a portion of a body of the user proximate a side of the user's joint;
an actuator configured to generate a torque to cause a movement of the interface to assist the user with movement of the joint; and
a controller configured to control the actuator to vary the magnitude of the torque generated by the actuator;
wherein the controller is further configured to one or more:
(i) operate as a finite state machine having one or more states, each of which correspond to a distinct portion of a cycle of the user's movement of the joint, and vary the magnitude of torque generated by the actuator based, at least in part, on a current state of the finite state machine;
(ii) vary the magnitude of the torque generated by the actuator based, at least in part, on the equation:
τᵢ=k(θᵢ−θ_{equilibrium})−b\dot{θ}ᵢ
wherein θᵢ refers to joint angle, \dot{θ}ᵢ refers to joint velocity, k refers a stiffness constant, b refers to a damping coefficient, and θ_{equilibrium} is an equilibrium angle which is a target joint angle; and/or
(iii) vary the magnitude of the torque generated by the actuator by using a user-independent real-time machine learning model which implements a convolutional neural network.

27. The exoskeleton of claim 26, wherein the actuator comprises a planetary gear system.

28. The exoskeleton of claim 10, wherein the controller is further configured as an impedance controller to vary the magnitude of the torque based on one or more kinematic measurements of the user's movement.

29. (canceled)

30. The exoskeleton of claim 1, wherein the controller is further configured to:
operate as a finite state machine having one or more states, each of which correspond to a distinct portion of a cycle of the user's movement of the joint; and
vary the magnitude of torque generated by the actuator based, at least in part, on a current state of the finite state machine.

31. The exoskeleton of claim 1, wherein the controller is further configured to vary the magnitude of the torque generated by the actuator based, at least in part, on the equation:
τᵢ=k(θᵢ−θ_{equilibrium})−b\dot{θ}ᵢ
wherein θᵢ refers to joint angle, \dot{θ}ᵢ refers to joint velocity, k refers a stiffness constant, b refers to a damping coefficient, and θ_{equilibrium} is an equilibrium angle which is a target joint angle.

32. The exoskeleton of claim 1, wherein the controller is further configured to vary the magnitude of the torque generated by the actuator by using a user-independent real-time machine learning model which implements a convolutional neural network.

33. The exoskeleton of claim 32, further comprising a plurality of sensors, wherein the user-independent real-time machine learning model receives input from the plurality of sensors.

34. The exoskeleton of claim 33, wherein at least two of the plurality of sensors comprises:
an encoder positioned proximate the joint of the user; and
an inertial measurement unit positioned proximate the interface.

35. The exoskeleton of claim 26, wherein the joint is a knee joint.
